(19) United States
(12) Patent Application Publication
(10) Pub. No.: US 2024/0398117 A1
(43) Pub. Date: Dec. 5, 2024

(54) CABINET

(71) Applicant: IKEA Supply AG, Pratteln (CH)

(72) Inventors: David Zeberg, Kyrkhult (SE); Mauricio Affonso, Malmo (SE)

(21) Appl. No.: 18/690,717

(22) PCT Filed: Sep. 9, 2022
(86) PCT No.: PCT/SE2022/050800

§ 371 Date: Mar. 8, 2024

(30) Foreign Application Priority Data
Sep. 10, 2021 (SE) 2151117-5

(51) Int. Cl. A47B 83/04; A47B 46/00; A47B 96/02

(52) U.S. Cl. CPC A47B 83/045; A47B 46/005; A47B 96/02

(57) ABSTRACT

A cabinet may include a top surface and a front side allowing access to an interior of the cabinet. The cabinet may also include a front panel, which may have a flat surface that is larger than the top surface. The front panel may be pivotable between a first configuration, in which the front panel is a vertical panel closing the front side, and a second configuration, in which the front panel forms a horizontal table top.

### CROSS-REFERENCE TO RELATED APPLICATIONS

This application claims priority to International Patent Application No. PCT/SE2022/050800, filed on Sep. 9, 2022, and Swedish Patent Application No. SE 2151117-5, filed on Sep. 10, 2021, the contents of both of which are hereby incorporated by reference in their entirety.

### TECHNICAL FIELD

The present invention relates to a cabinet and a method for forming a table from said cabinet.

### BACKGROUND

Cabinets are commonly used in households to store various types of items. The cabinet is normally accessed from a front side being provided with some kind of cover, which can be opened. The cover may e.g. be in the form of hinged doors, sliding doors, or they may be in the form of sliding drawers being pulled in and out from the cabinet.

The upper surface of the cabinet provides a flat surface that can be further used for placement of items. However, in compact living, each area of a room is normally considered for providing additional functionality. Therefore, cabinets having a flat upper surface can be used as a desk or as a table. Obviously, such versatile use comes with drawbacks; the depth of cabinets is normally quite small, leaving the usable desk area of the cabinet to be unsuitably tiny. Further, as the front side of the cabinet is normally aligned with the front edge of the upper surface leaving no room for the legs of a user sitting at the cabinet and using the upper surface as a desk or table.

In view of this, it would be advantageous to provide a cabinet, which can also be used as a desk or table in an improved manner as compared to prior art.

### SUMMARY

The present invention seeks to mitigate, alleviate, eliminate or circumvent one or more of the above identified deficiencies in the art and disadvantages singly or in any combination by providing in a first aspect a cabinet comprising a top surface and a front side allowing access to an interior of the cabinet, and a front panel having a flat surface being larger than the top surface of the cabinet. The front panel is pivotable between a first configuration, in which the front panel is a vertical panel closing the front side, and a second configuration, in which the front panel forms a horizontal table top. This cabinet is advantageous in that it provides both a storage unit with a closed front side and a cabinet which can form a table top. Thus, the cabinet has a dual function and saves space since it is a “two-in-one”-type of furniture. Hence, the cabinet provides both storage space and a desk or table top surface. It is easy to convert between the two configurations and can quickly be transformed between its storage configuration (the first configuration) and the table configuration (the second configuration). Moreover, since the flat surface of the front panel is larger than the top surface of the cabinet, the desk and/or table top formed from the flat surface has a generous surface area compared to other versatile use furniture.

In one embodiment, the cabinet further comprises two outer side panels, and the front panel is attached to the outer side panels with rotatable connection means.

The front panel may have two side walls each extending externally of and in parallel with the two outer side panels of the cabinet, and each one of the outer side panels may be connected to one of the two side walls by the rotatable connection means, respectively. This is advantageous in that the two side walls of the front panel may cover the rotatable connection means, which both protects the connection means and provides an aesthetically pleasing cabinet where the connection means are hidden.

In another embodiment, the front panel comprises an engagement means configured to engage a mating connecting means provided on a base of the cabinet. At least one internal surface of the front panel may comprise the engagement means configured to engage the mating connecting means provided on at least one of the outer side panels when the front panel is in the second configuration.

In yet another embodiment, the rotatable connection means comprises an integrated damper. This provides a smooth pivoting movement of the front panel from the first to the second configuration, and vice versa.

In a further embodiment, a horizontal rotational axis extends along a back surface of a base of the cabinet, and a pivot point is arranged in a rear half of a depth of the base. The cabinet may comprise two pivot points.

In one embodiment, a bottom surface of the cabinet has a depth greater than a depth of the side panels and the top surface and wherein the bottom surface further comprises a chamfer arranged along a front edge of the bottom surface.

The cabinet may further comprise at least one internal horizontal shelf and/or a vertical dividing panel.

The cabinet may further comprise legs extending vertically from the bottom surface.

In one embodiment, in the second configuration, the front panel is arranged vertically above the top surface.

In a further embodiment, in the second configuration, a front edge of the front panel is arranged horizontally in front of a front edge of the top surface. This is advantageous in that the user is provided with a space between the table top and the front edge of the top surface of the base of the cabinet.

In another embodiment, the front panel is pivotable to a third configuration in which the front panel forms a horizontal table top at a vertical position being higher than a vertical position of the table top when arranged in the second configuration. This is beneficial since the cabinet can provide a horizontal table top with variable height. Thus, users of different height can use the formed table top without difficulty.

In one embodiment, in the second configuration, a gap is present between the top surface and the horizontal table top. This mitigates the risk of damaging the top surface and/or causing scratches on the top surface. It is also beneficial since the cabinet can have a height substantially lower than the height required for a table top.

The rotatable connection means may comprise a first arm and a second arm each rotatably connected to one of the outer side panels and the side walls. Preferably, the first arm is a front arm arranged closest to the front panel of the cabinet and the second arm is a rear arm arranged closest to a back surface of the cabinet. This is advantageous in that one arm may act as a support bracket in the second configuration strengthening the table top and the other arm may act as a guiding bracket when moving the front panel between the first and second configuration.

The first arm may comprise an extendable member. In such case, the extendable member may comprise a sleeve configured to hold in a non-extended configuration an elongated pin being at least partly withdrawn from the sleeve when the vertical panel is arranged in the second configuration.

In one embodiment, the sleeve is also an integrated damper.

In a further embodiment, the second arm or the first arm abuts a supporting pin extending outwardly from the side panel of the cabinet in the second configuration. This is beneficial since the pin prevents the table top surface from being pushed further backwards, creating a stable table top.

In a second aspect, there is provided a method for forming a table from a cabinet. The method comprises the steps of providing a cabinet, and lifting the front panel of the cabinet upwardly in a vertical direction pivoting the front panel from a first configuration, in which the front panel is a vertical panel closing the front side, to a second configuration, whereby the front panel forms a horizontal table top.

In one embodiment, the method further comprises a step of connecting an engagement means provided on an internal surface of the front panel with a mating connecting means arranged on an outer side panel of a base of the cabinet.

Further advantageous features of the invention are elaborated in embodiments disclosed herein. In addition, advantageous features of the invention are defined in the dependent claims.

### BRIEF DESCRIPTION OF THE DRAWINGS

These and other aspects, features and advantages of which the invention is capable of will be apparent and elucidated from the following description of embodiments of the present invention, reference being made to the accompanying drawings, in which:

FIG. 1 shows isometric views of a cabinet according to the invention;

FIG. 2 shows side views of the isometric views shown in FIG. 1;

FIG. 3 shows isometric views of a cabinet according to another embodiment of the invention;

FIG. 4 shows side views of the isometric views shown in FIG. 3;

FIG. 5 shows isometric views together with a user of the two cabinets shown in FIGS. 1 and 2, and 3 and 4, respectively;

FIG. 6 shows isometric views of a cabinet according to the invention with two pivot points;

FIG. 7 shows an exemplary rotatable connection means comprising a damper;

FIG. 8 shows a cabinet according to another embodiment of the invention;

FIGS. 9a through 12b show a cabinet according to yet another embodiment of the invention; and

FIGS. 13a through 14b show a cabinet according to a further embodiment of the invention.

### DETAILED DESCRIPTION

Hereinafter, certain embodiments will be described more fully with reference to the accompanying drawings. The invention may, however, be embodied in many different forms and should not be construed as limited to the embodiments set forth herein. Rather, these embodiments are provided by way of example so that this disclosure will be thorough and complete, and will fully convey the scope of the invention, such as it is defined in the appended claims, to those skilled in the art.

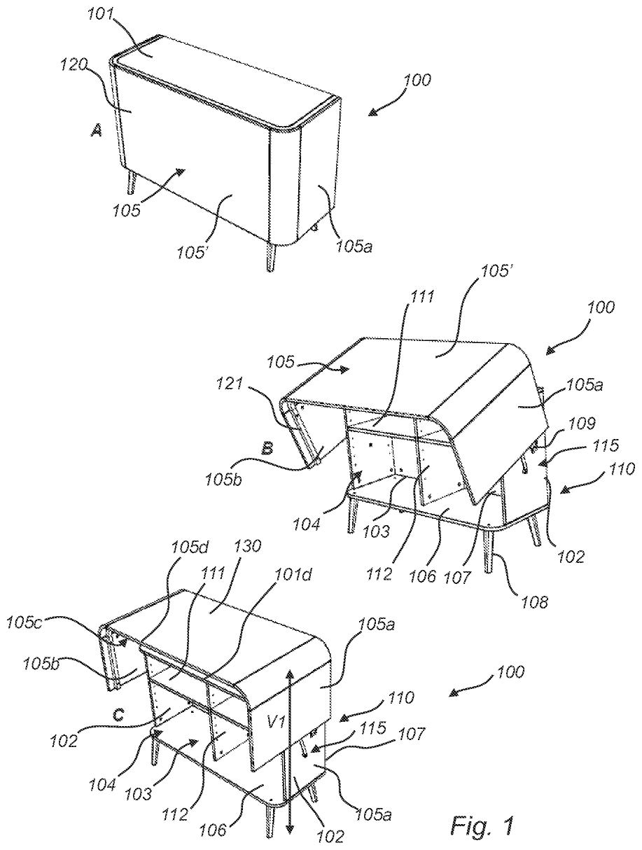

With reference to FIG. 1, isometric views of a cabinet 100 in three different configurations A, B, C are shown. As shown in a first configuration A, the cabinet 100 has a top surface 101, and a front panel 105 having two side walls 105a, 105b (only one side wall 105a is visible in the first configuration A), and a flat surface 105′ forming a vertical panel 120.

The vertical panel 120 shown in FIG. 1 closes a front side 104 of the cabinet 100 (shown in an intermediate configuration B and a second configuration C). The front panel 105 is pivotable between the first configuration A, and the second configuration C, in which the front panel 105 forms a horizontal table top 130.

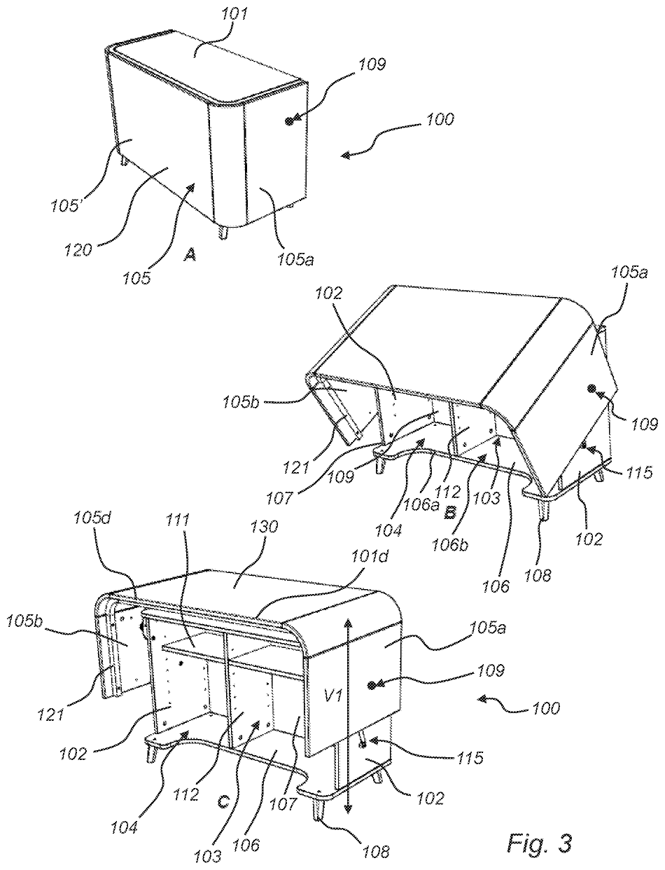

In the intermediate configuration B and the second configuration C, a base 110 of the cabinet 100 is visible. The base 110 is formed of the top surface 101, two outer side panels 102, a bottom surface 106 and a back surface 107. The cabinet 100 also comprises four legs 108 extending vertically downwards from the bottom surface 106. The legs 108 may have variable length and shape. Further, the cabinet 100 comprises an interior 103, preferably comprising at least one a horizontal shelf 111 and/or a vertical dividing panel 112 as shown in FIG. 1. The cabinet 100 may optionally comprise drawers in the interior 103 (not shown). In addition, the vertical panel 120 comprises an interior lath 121 running along the inside of the side walls 105a, 105b and the front panel 105, as shown in FIGS. 1 and 3.

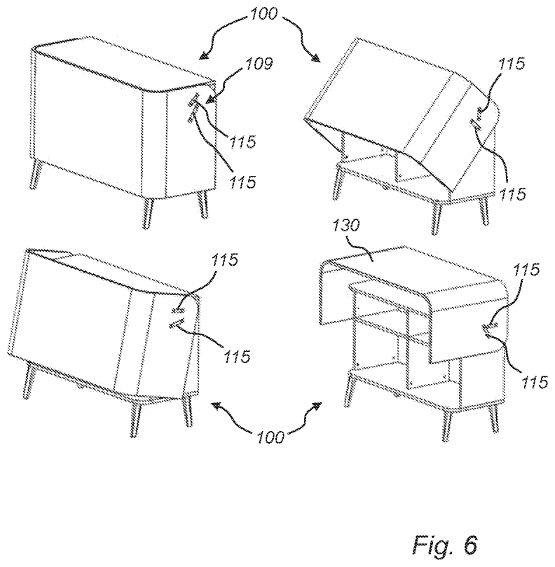

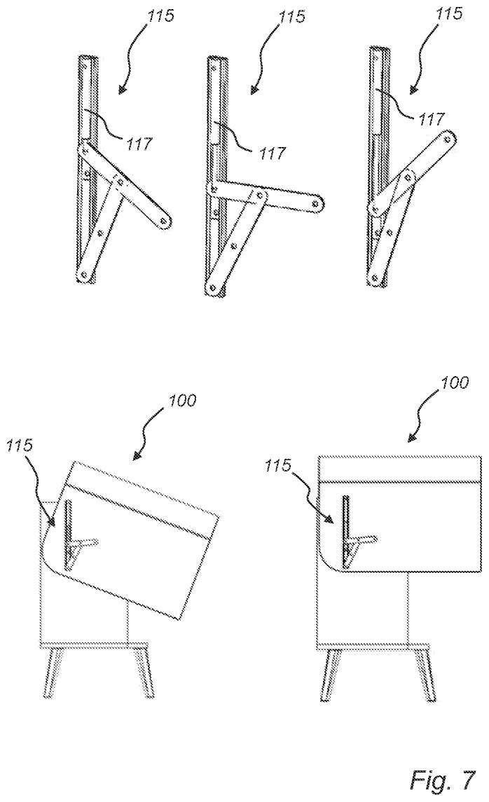

To arrive at the second configuration C, the front panel 105 is lifted vertically, upwards, via the intermediate configuration B, as shown in FIG. 1. The front panel 105 is rotatable about a pivot point 109 and is connected to the base 110 of the cabinet 100 through rotatable connection means 115 (shown in for example FIGS. 6 and 7). In FIG. 1, each side wall 105a, 105b of the front panel 105 is connected to one of the outer side panels 102 of the base 110 by the rotatable connection means 115 (shown in for instance FIG. 7), respectively.

When the front panel 105 is lifted and forms the horizontal table top 130, a space is present between the top surface 101 of the cabinet 100 and the table top 130. Hence, there is a gap between the top surface 101 and the horizontal table top 130. Thus, the front panel 105 cannot damage the top surface 101 of the cabinet 100 in the second configuration C. If the front panel 105 had rested on top of the top surface 101 in the second configuration C, the front panel 105 could potentially scratch the tope surface 101 or leave other marks thereon.

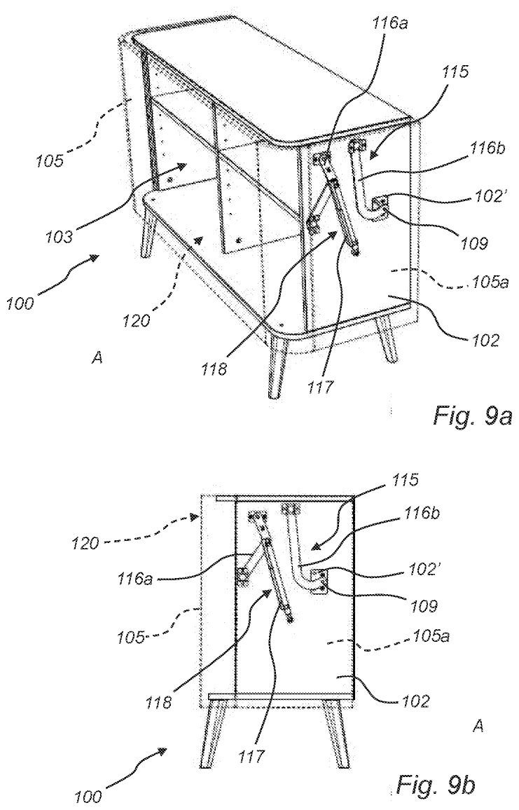

Exemplary rotatable connection means 115 are shown in FIGS. 7-14b. However, any connection means allowing the front panel 105 to be lifted between the first configuration A and the second configuration C may be used to connect the front panel 105 to the base 110 of the cabinet 100. The connection means 115 may for instance be a bracket, a bolt or a screw. In some embodiments, the connection means 115 may comprise a first arm 116a and a second arm 116b, as shown in FIGS. 9a-14b. Optionally, the front panel 105 is connected to the panel forming the top surface 101 of the cabinet 100.

The side walls 105a, 105b of the front panel 105 each extend externally of and in parallel with the two outer side panels 102 of the cabinet 100. Optionally, the side walls 105a, 105b may extend internally of and in parallel with the two outer side panels 102 (not shown).

As shown in the second configuration C, the flat surface 105′ of the front panel 105 is larger than the top surface 101 of the cabinet 100. Hence, the formed table top 130 has a surface area corresponding to that of the flat surface 105′. This provides a cabinet 100 which takes up a smaller space in a room in configuration A than in configuration C. Thus, the cabinet 100 provides a neat cabinet 100 which can provide a table top 130 having a larger surface area.

The table top 130 has a vertical position V1 above a ground level, as indicated in configuration C in FIG. 1. In the vertical position V1, the table top 130 is located higher from the ground level than the top surface 101 of the cabinet 100, whereby a gap is formed between the top surface 101 and the table top 130. The cabinet 100 may therefore have a height which is lower than the vertical position V1 required for a desk top or table top. Further, the front panel 105 has a front edge 105d arranged horizontally in front of a front edge 101d of the top surface 101. This space provides leg room or sufficient space for a seating furniture for the user.

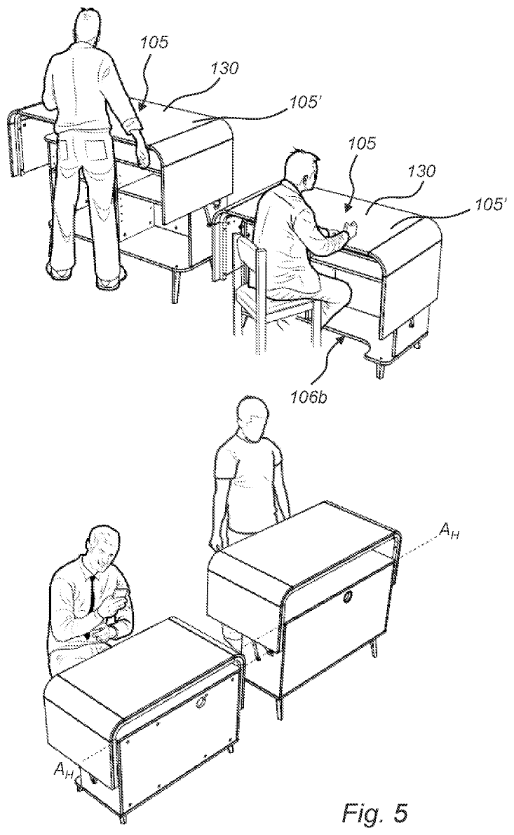

The cabinet 100 shown in FIG. 1 is a cabinet 100 forming a standing desk formation in the second configuration C, as shown in FIG. 5.

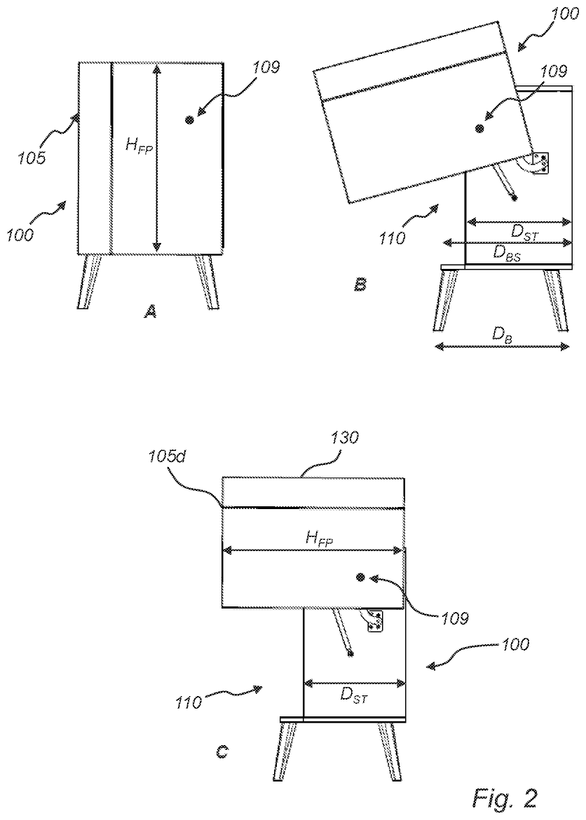

FIG. 2 shows side views of the cabinet 100 displayed in FIG. 1. As shown in FIG. 2, the flat surface 120 of the front panel 105 is lifted and pivoted from the first configuration A, to the intermediate configuration B, to finally form the horizontal table top 130 in the second configuration C.

The front panel 105 has a height H_{FP} with is greater than a depth D_{ST} of the side panels 102 and the top surface 101 of the base 110 of the cabinet 100. This provides a table top 130 which extends beyond the front side 104 of the cabinet 100. Thus, the front edge 105d of the front panel 105 forming the table top 130 extends beyond the front side 104 and the front edge 101d of the top surface 101 in a horizontal direction. As described above, this provides leg room and space for e.g. a stool. In addition, the design yields a table top 130 with a larger surface area than the surface area of the cabinet 100 as seen from above. Hence, the cabinet 100 takes up a smaller space in configuration A, which is advantageous in small living spaces.

Further, the base 110 has a depth DB and the bottom surface 106 has a depth D_{BS}. The depth D_{BS} of the bottom surface 106 is larger than the depth D_{ST} of the side panels 102 and the top surface 101. The pivot point 109 is arranged in a rear half of a depth DB of the base 110 and a rear half of the depth D_{ST}. The pivot points 109 are arranged along a horizontal rotational axis A_{H} (shown in FIG. 5) in parallel with the back surface 107 of a base 110 of the cabinet 100. The cabinet 100 shown in FIGS. 1 and 2 comprises two pivot points 109, each arranged in one of the side walls 105a, 105b and the one of the respective outer side panels 102. However, the cabinet 100 may comprise fewer or more pivot points 109.

Thus, the front panel 105 is pivotable relative to the base 110 along the horizontal rotational axis A_{H} about the pivot point 109, and the front panel 105 is pivotable between the first configuration A, in which the front panel 105 is a vertical panel 120 covering articles stored inside the cabinet 100, and the second configuration C, in which the front panel 105 forms the horizontal table top 130. Hence, the horizontal rotational axis A_{H} extends along the width of the back surface 107, said back surface 107 extending between the side panels 102 of the cabinet 100. The horizontal rotational axis A_{H} therefore extends between the side panels 102. The horizontal rotational axis A_{H} extends in a direction perpendicular to the bottom surface 106 of the cabinet 100.

With reference to FIG. 3, a cabinet 100 providing a sitting desk or table in the second configuration C is shown. The cabinet 100 in FIG. 3 also comprises a base 110, having a top surface 101, two outer side panels 102, a bottom surface 106 and a back surface 107. The cabinet 100 has an interior 103 and a front side 104. To arrive at the second configuration C where the flat surface 105′ forms a table top 130, the front panel 105 of the cabinet 100 is lifted in the same manner as described with referenced to the cabinet in FIGS. 1 and 2 above. Two side walls 105a, 105b of the front panel 105 are each attached to a respective side surface 102 of the cabinet 100 by a connection means 115 (not shown). The connection means 115 facilitates rotational movement of the front panel 105 such that the front panel 105 can be moved from the first configuration A to the second configuration C.

The legs 108 shown in FIG. 3 are shorter than the legs 108 in FIGS. 1 and 2. Further, as shown in configuration B and C in FIG. 3, the bottom surface 106 of the cabinet 100 further comprises a chamfer 106b arranged along a front edge 106a of the bottom surface 106. The cabinet 100 shown in FIGS. 1 and 2 may also be provided with such chamfer. The chamfer 106b provides additional leg room for the user, as shown in e.g. FIG. 5.

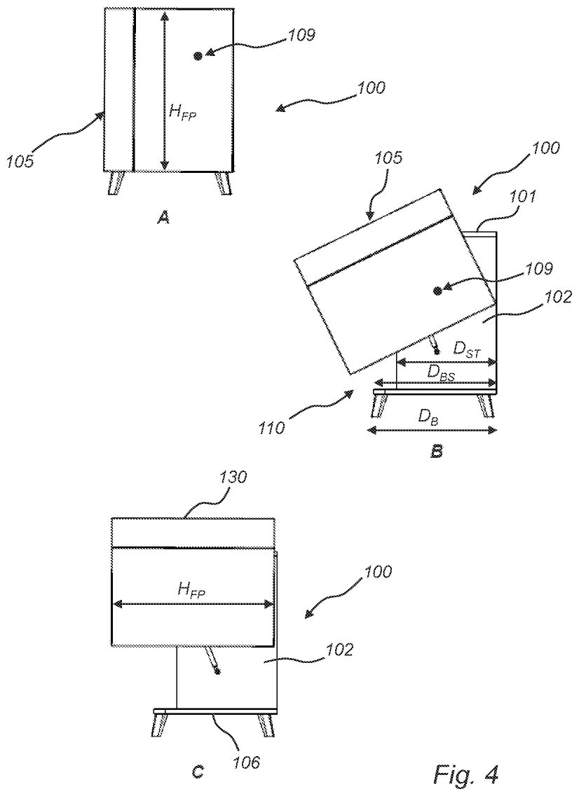

FIG. 4 shows side views of the configurations A, B, C of the cabinet 100 shown in FIG. 3. The pivot points 109 of the cabinet 100 in FIG. 4 are arranged towards the front of a depth D_{ST} of the side panels 102 and the top surface 101. The height H_{FP} of the front panel 105 is greater than the depth DB of the base 110 and the depth D_{BS} of the bottom surface 106.

FIG. 5 shows the two cabinets 100 from FIGS. 1-4 in the second configuration C. The front panels 105 have been lifted vertically upwards such that the flat surface 105′ forms the table top 130. The chamfer 106b facilitates the seating arrangement of the user, such that the user can pull for instance a chair close to the table top 130. Further, the front panel 105 shown in FIGS. 1 to 5 has rounded corners between the flat surface 105′ and the side walls 105a, 105b.

The vertical position of the table top 130 can be adjusted either by varying the length of the legs 108 of the cabinet 100, and/or by adjusting the positioning of the rotatable connection means 115 and/or the pivot point 109. Optionally, the front panel 105 may be pivotable to a third configuration in which the front panel 105 forms a horizontal table top at a vertical position V2 (not shown) being higher than a vertical position V1 of the table top 130 when arranged in the second configuration C. With reference to FIG. 6, the cabinet 100 comprises two pivot points 109. This arrangement provides a cabinet 100 which can be provided with a table top 130 in two different vertical positions V1, V2. Alternatively, the rotatable connection means 115 has two or more levels integrated therein to provide different vertical positions, V1, V2, etc. of the table top 130 in the second configuration C.

Optionally, the front panel 105 may be arranged at an angle, being inclined towards the user (not shown). An inclined table top 130 is preferable if for instance the table top 130 is to be used as a drawing board.

The rotatable connection means 115 provides support for the table top 130, and holds the table top 130 in its horizontal position in the second configuration C. Hence, the table top 130 is held in its upright position in the second configuration C by being supported by the connection means 115. Therefore, the front panel 105 does not need to rest on top of the top surface 101 of the cabinet 100 in order to for the horizontal table top 130.

FIG. 7 shows an example of a rotatable connection means 115 in the form of a bracket comprising an integrated damper 117. The damper 117 facilitates a smooth movement of the front panel 105 between the first and second configuration A, C.

Optionally, the front panel 105 comprises an engagement means configured to engage a mating connecting means provided on the base 110 of the cabinet 100. Preferably, at least one internal surface 105c of the front panel 105 comprises the engagement means configured to engage the mating connecting means, which is preferably provided on at least one of the outer side panels 102 when the front panel 105 is arranged in the second configuration C.

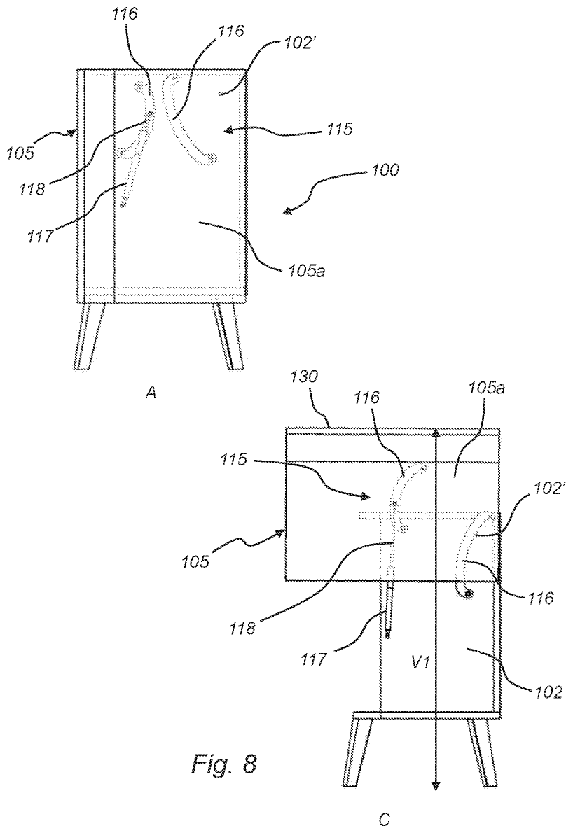

With reference to FIG. 8, the cabinet 100 comprising another type of connection means 115 is shown. The cabinet 100 in FIG. 8 is shown in the first configuration A and the second configuration C. The connection means 115 is formed of two separate arms 116, and an extendable bar 118 movably connected in one end to one of the arms 116 and in the other end to the outer side panel 102. The extendable bar 118 is connected to the arm 116 closest to the front side of the cabinet 100. The outer side panel 102 of the cabinet 100 is also provided with a plug 102′.

One end of each arm 116 is movably connected to the outer side panel 102 of the cabinet 100, while the other end is movably connected to an internal surface 105c of the side wall 105a of the front panel 105. The extendable bar 118 further comprises an optional damper 117.

In the first configuration A in FIG. 8, the cabinet 100 is closed. To open the cabinet 100 and to form a table top 130 of the front panel 105, the front panel 105 is lifted upwards, as described above with reference to FIGS. 1 to 7. The movable connections between the arms 116, the outer side panel 102, the side wall 105 and the extendable bar 118 are all rotatably connected, and the connection between the extendable bar 118 and the outer side panel 102 is also rotatable. Hence, when the user lifts the front panel 105 upwards from the first configuration A, the extendable bar 118 expands in length and the front panel 105 is moved outwards in a horizontal direction and upwards. When the table top 130 has reached its highest position, the table top 130 is pushed backwards towards the back surface 107 until the rear arm 116 reaches the plug 102′, acting as a stopping member for the connection means 115.

To close the cabinet 100 and return to the first configuration A from the second configuration C, the user pulls the table top 130 in a horizontal direction, towards the front side 104, and then pushes the front panel 105 downwards. Hence, the connection mechanism 115 shown in FIG. 8 provides a strong table top 130 in the second configuration C, withstanding high loads placed on top thereof since a horizontal movement of the front panel 105 is required to close the cabinet 100. This provides additional safety for the user.

Moreover, the vertical position V1 of the table top 130 in the second configuration C can be adjusted by adapting the length of the arms 116 (not shown).

With reference to FIGS. 9a-12b, a cabinet 100 according to another embodiment of the invention is shown. The cabinet 100 comprises another type of rotatable connection means 115. The cabinet 100 of FIGS. 9a-12b comprises a connection means 115 formed of two separate arms 116a, 116b, and an extendable bar 118 movably connected in one end to one of the arms 116a and in the other end to the outer side panel 102. The extendable bar 118 is connected to the arm 116a closest to the front side of the cabinet 100, i.e. to the front arm 116a.

Further, a bracket connected to the outer side panel 102 of the cabinet 100 and to a lower end of the arm 116b closest to the rear side of the cabinet 100, i.e. the rear arm 116b, is provided with a plug 102′.

One end of each arm 116a, 116b is movably connected to the outer side panel 102 of the cabinet 100, while the other end is movably connected to an internal surface 105c of the side wall 105a of the front panel 105. The extendable bar 118 further comprises an optional damper 117.

In FIGS. 9a-12b, an upper end of the rear arm 116b is attached to an inner surface of the side ends 105a, 105b of the vertical panel 120, and a lower end of the arm 116b is attached to the side 102 of the cabinet 100. The rear arm 116b is rotatable about a pivot point 109.

An upper part of the front arm 116a is attached to the outer side panel 102 of the cabinet 100 and a lower part of the front arm 116a is attached to an inner surface of the side ends 105a, 105b of the vertical panel 120. A lower end of the extendable bar 118 is also fixed to the side panel 102 of the cabinet 100.

In FIGS. 9a and 9b, the cabinet 100 is in its closed configuration A, where the front panel 105 covers the opening 104 of the base 110 of the cabinet 100. The vertical panel 120 is drawn in dashed lines as a see through panel to show the interior 103 (shown in FIG. 9a) and the side panel 102 of the cabinet 100 (shown in FIGS. 9a and 9b).

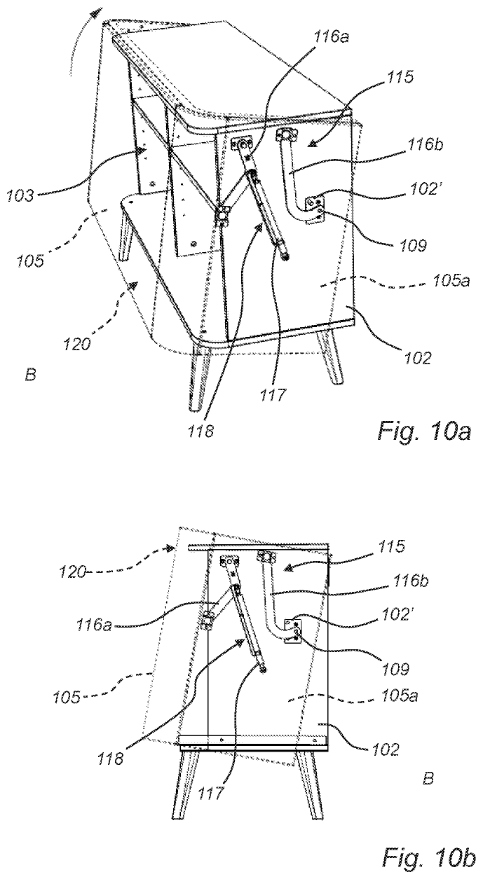

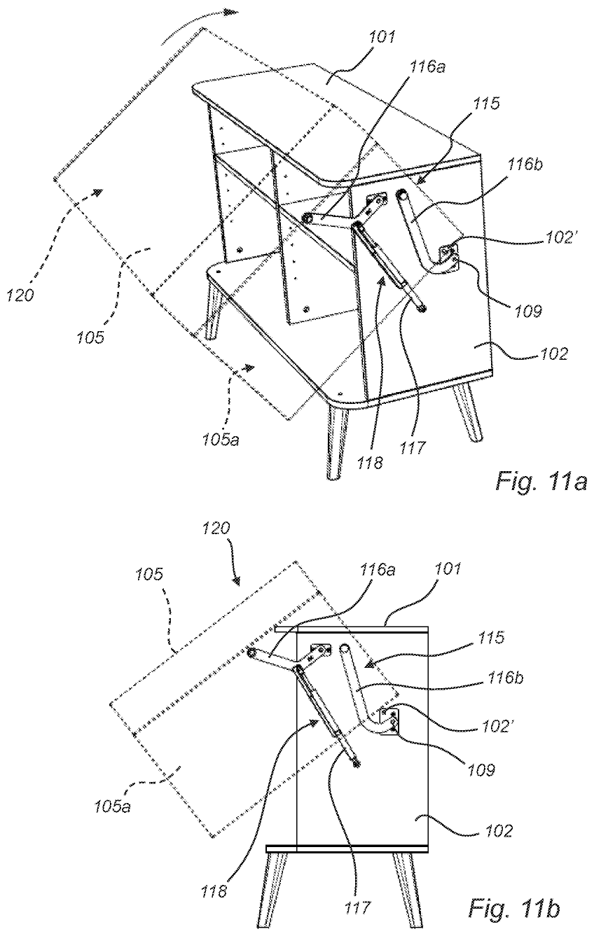

To open the cabinet 100 and to form a table top 130 of the front panel 105, the front panel 105 is lifted upwards, as described above with reference to FIGS. 1 to 8. In FIGS. 10a-11b, the cabinet 100 is shown in the intermediate configuration B, where the extendable bar 118 is extending as the front panel 105 is lifted upwards as indicated by the arrows shown in FIGS. 10a and 11a. The movable connections between the arms 116a, 116b, the outer side panel 102, the side wall 105 and the extendable bar 118 are all rotatably connected, and the connection between the extendable bar 118 and the outer side panel 102 is also rotatable. Hence, when the user lifts the front panel 105 upwards from the first configuration A, the extendable bar 118 expands in length as shown in FIGS. 10a-12b and the front panel 105 is moved outwards in a horizontal direction and upwards. When the front panel 105 has reached its highest position, the front panel 105 is pushed backwards towards the back surface 107 until the rear arm 116b reaches the plug 102′. The plug 102′ acts as a stopping member for the connection means 115. Hence, in the second configuration C, the rear arm 116b of the connection means 115 abuts the plug 102′ such that the front panel 105 cannot be pushed further backwards.

To close the cabinet 100 and return to the first configuration A from the second configuration C, the user pulls the table top 130 in a horizontal direction, towards the front side 104, and then pushes the front panel 105 downwards. Hence, the connection mechanism 115 shown in FIG. 9a-12b provides a strong table top 130 in the second configuration C, withstanding high loads placed on top thereof since a horizontal movement of the front panel 105 is required to close the cabinet 100. This provides additional safety for the user.

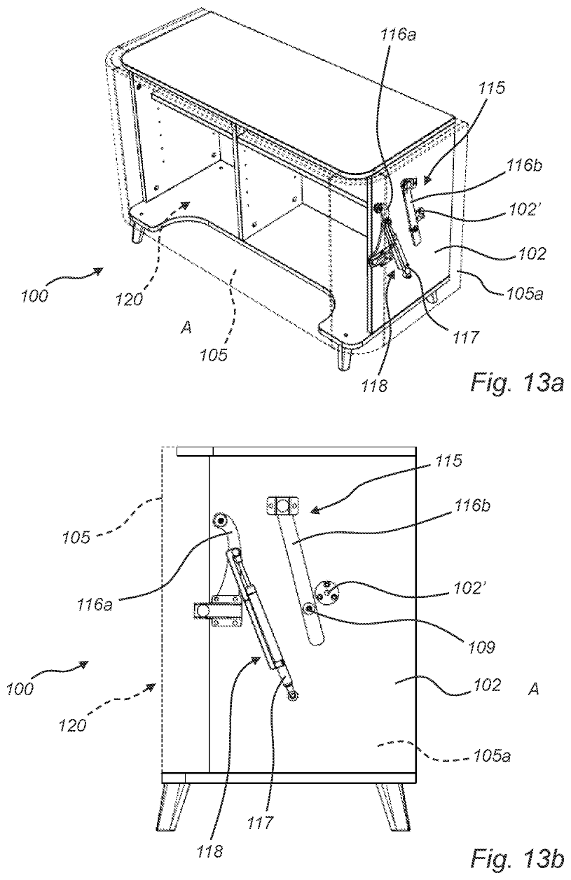

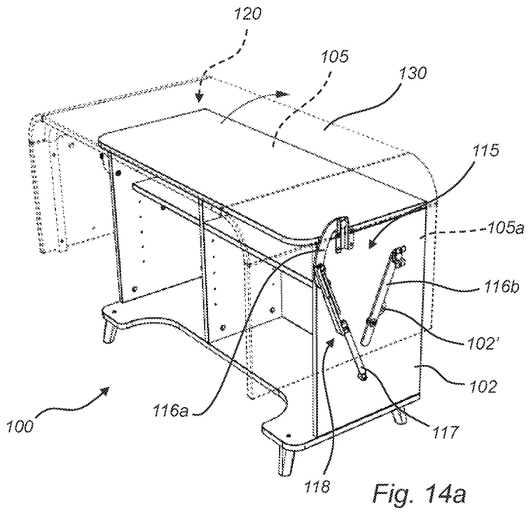

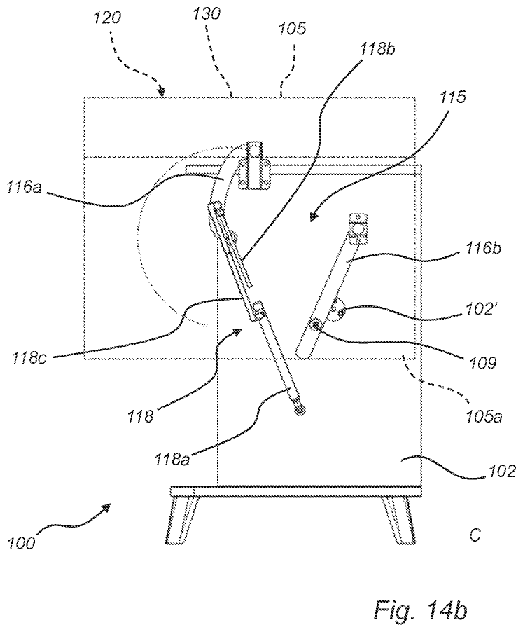

FIGS. 13a-14b show a cabinet 100 according to yet another embodiment of the invention. This cabinet 100 comprises yet another type of connection means 115. The connection means 115 in FIGS. 13a-14b also comprises a front arm 116a, a rear arm 116b, and an extendable bracket member 118 provided with an optional integrated damper 117.

The lower end of the rear arm 116b is attached to the outer side panel 102 of the cabinet 100 and is rotatable such that the arm 116b is pivotable about the pivot point 109. The upper end of the rear arm 116b is connected to the internal surface 105c of the side wall 105a of the vertical panel 120. An upper end of the front arm 116a is rotatably connected to the to the outer side panel 102 and the lower end of the front arm 116a is attached to the internal surface 105c of the side wall 105a of the vertical panel 120.

To transform the cabinet 100 shown in FIGS. 13a-13b into the second configuration C as shown in FIGS. 14a-14b, the user lifts the vertical panel 120 upwards and then pushes it in a rearwardly horizontal direction, as explained with reference to FIGS. 8-12b above, and as indicated by the arrow in FIG. 14a.

FIG. 14b shows the cabinet 100 from FIGS. 13a-14a in the second configuration C seen from the side. The vertical panel 120 is displayed as a see through panel such that the connection means 115 formed of the front arm 116a, the rear arm 116b and the extendable member 118 can be visualised. The dashed arrow shaped as a half circle indicates the movement of the front arm 116a and the extendable member 118 when lifting the vertical panel 120 to form the table top 130. The extendable member 118 comprises a sleeve 118a, an elongated pin 118b and a guide bar 118c. The sleeve 118a encloses the elongated pin 118b in the first configuration A shown in FIGS. 13a-13b. The sleeve 118a slidingly engage the elongated pin 118b when the vertical panel 120 is brought from the second configuration C to the first configuration A. When the vertical panel 120 is moved, the guide bar 118c slide along an outer surface of the sleeve 118a. the sleeve 118a may also be an integrated damper 117.

The rear arm 116b in FIG. 14b abuts the pin 102′ preventing the arm 116b from being pushed further rearwards.

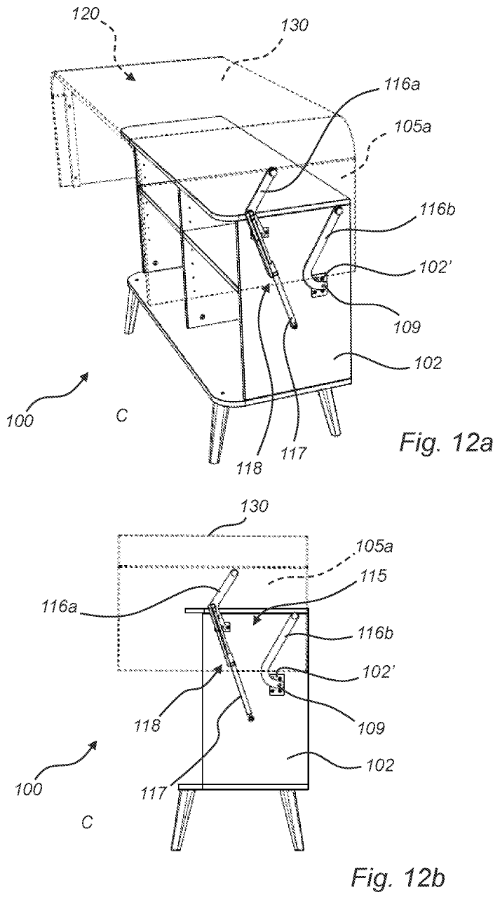

The vertical position V1 of the table top 130 shown in FIGS. 12a-12b and 14a-14b in the second configuration C can be adjusted by adapting the length of the arms 116a, 116b (not shown).

The rotatable connection means 115 in FIGS. 8-14b comprises two separate arms 116a, 116b each rotatably connected in one end to the side panel 102 and in the other end to the inner surface 105c of the side panel 105a, 105b. The rear arm 116b acts as an abutment support structure together with a pin 102′ extending outwardly from the side panel 102. Optionally, the first arm 116a may act as the abutment support structure resting on the pin 102′.

The arms 116a, 116b may be straight, or be J-, C- or V-shaped as shown in FIGS. 9a-14b.

The cabinets 100 disclosed in FIGS. 9a-14b all have the same advantages as described with reference to FIGS. 1-8 above.

Without further elaboration, it is believed that one skilled in the art may, using the preceding description, utilize the present invention to its fullest extent. The preceding preferred specific embodiments are, therefore, to be construed as merely illustrative and not limitative of the disclosure in any way whatsoever.

Although the present invention has been described above with reference to specific embodiments, it is not intended to be limited to the specific form set forth herein. Rather, the invention is limited only by the accompanying claims and, other embodiments than the specific above are equally possible within the scope of these appended claims, e.g. different than those described above.

In the claims, the term “comprises/comprising” does not exclude the presence of other elements or steps. Additionally, although individual features may be included in different claims, these may possibly advantageously be combined, and the inclusion in different claims does not imply that a combination of features is not feasible and/or advantageous.

In addition, singular references do not exclude a plurality. The terms “a”, “an”, “first”, “second” etc. do not preclude a plurality.

1. A cabinet, comprising:
a top surface and a front side allowing access to an interior of the cabinet; and
a front panel having a flat surface that is larger than the top surface; and
wherein the front panel is pivotable between a first configuration, in which the front panel is a vertical panel closing the front side, and a second configuration, in which the front panel forms a horizontal table top.

2. The cabinet according to claim 1, further comprising two outer side panels, wherein the front panel is attached to the two outer side panels via a rotatable connection mechanism.

3. The cabinet according to claim 2, wherein:
the front panel includes two side walls each extending externally of and in parallel with the two outer side panels; and
each of the two outer side panels is connected to one of the two side walls by via the rotatable connection mechanism, respectively.

4. The cabinet according to claim 1, further comprising a base, wherein the front panel includes an engagement mechanism configured to engage a mating connecting a mechanism disposed on the base.

5. The cabinet according to claim 4, wherein:
the base includes two outer side panels;
the mating connecting mechanism is disposed on at least one of the two outer side panels;
at least one internal surface of the front panel includes the engagement mechanism; and
the engagement mechanism is further configured to engage the mating connecting mechanism when the front panel is in the second configuration.

6. The cabinet according to claim 2, wherein the rotatable connection mechanism includes an integrated damper.

7. The cabinet according to claim 1, further comprising a back surface and a base, wherein;
a horizontal rotational axis extends along the back surface; and
a pivot point is arranged in a rear half of a depth of the base.

8. The cabinet according to claim 1, further comprising two pivot points.

9. The cabinet according to claim 2, further comprising a bottom surface, wherein:
the bottom surface has a depth greater than a depth of the two outer side panels and the top surface; and
the bottom surface includes a chamfer arranged along a front edge of the bottom surface.

10. The cabinet according to claim 1, further comprising at least one of:
at least one internal horizontal shelf; and
a vertical dividing panel.

11. The cabinet according to claim 1, further comprising a bottom surface and a plurality of legs extending vertically from the bottom surface.

12. The cabinet according to claim 1, wherein, when the front panel is in the second configuration, the front panel is arranged vertically above the top surface.

13. The cabinet according to claim 1, wherein, when the front panel is in the second configuration, a front edge of the front panel is arranged horizontally in front of a front edge of the top surface.

14. The cabinet according to claim 1, wherein the front panel is pivotable to a third configuration in which the front panel forms a horizontal table top at a vertical position that is higher than a vertical position of the table top formed when the front panel is in the second configuration.

15. The cabinet according to claim 1, wherein, when the front panel is in the second configuration, a gap is defined between the top surface and the horizontal table top.

16. The cabinet according to claim 2, wherein;
the front panel includes two side walls; and
the rotatable connection mechanism includes a first arm and a second arm each rotatably connected to one of the two outer side panels and one of the two side walls.

17. The cabinet according to claim 16, wherein the first arm includes an extendable member.

18. The cabinet according to claim 17, wherein:
the extendable member includes a sleeve configured to hold in a non-extended configuration an elongated pin; and
the elongated pin is at least partly withdrawn from the sleeve when the front panel is in the second configuration.

19. The cabinet according to claim 18, wherein the sleeve is an integrated damper.

20. The cabinet according to claim 16, wherein at least one of the second arm and the first arm abuts a supporting pin extending outwardly from one of the two side panels when the front panel is in the second configuration.

21. A method for forming a table from a cabinet, comprising:
providing the cabinet according to claim 1; and
lifting the front panel upwardly in a vertical direction to pivot the front panel from the first configuration to the second configuration and form the horizontal table top.

22. The method according to claim 21, further comprising connecting an engagement provided mechanism disposed on an internal surface of the front panel with a mating connecting mechanism arranged on an outer side panel of a base of the cabinet.
